(19) United States
(12) Patent Application Publication
(10) Pub. No.: US 2016/0345651 A1
(43) Pub. Date: Dec. 1, 2016

(54) Safety Helmet Liner Impact Reducing Technology

(71) Applicant: Paul William Dvorak, Gretna, LA (US)

(72) Inventor: Paul William Dvorak, Gretna, LA (US)

(21) Appl. No.: 14/721,017

(22) Filed: May 26, 2015

(51) Int. Cl. A42B 3/12; B29C 51/10; B29C 45/40; A42B 3/06

(52) U.S. Cl. CPC A42B 3/124; A42B 3/06; B29C 51/10; B29C 45/40; B29L 2031/4807

(57) ABSTRACT

An article of headwear includes an inner liner 20, a corrugated shell 24, and an outer shell 26. An impact to headwear causes the corrugated shell to elastically deform, with the shell then returning to its original shape. An arrangement of the corrugations allows ease of manufacturing on a vacuum form or injection mold.

### CROSS-REFERENCE TO RELATED APPLICATIONS

This application claims the benefit of PPA Ser. Nr. U.S. patent application Ser. No. 61/997,222, filed 2014 May 27 by the present inventor, which is incorporated by reference.

### FEDERALLY SPONSORED RESEARCH

Not applicable

### SEQUENCE LISTING OR PROGRAM

Not applicable

### BACKGROUND

1. Field of Invention

This invention relates to wearable protective equipment, specifically to helmets and other shells intended to reduce the effect of impacts.

2. Prior Art

Helmets are known to have existed for almost 3000 years. Originally they were made of bronze, iron and leather to protect soldiers in battle. Over time, they evolved to protect people in a variety of fields, including construction, firefighting, and a variety of sports. In each application, designers have had to meet specific demands, but the general goal has always been to protect the head against blunt or pointed impacts.

In the past century, helmets have seen improvements in weight and comfort through the addition of various plastics, foams, and advanced manufacturing techniques. These began with the first plastic football helmet patented by John T. Riddell and his son John T. Riddell Jr. in 1940, U.S. Pat. No. 2,293,308. The advances continued in the development of highly specialized helmets for applications including, batting, cricket, bicycle, rock climbing, motorcycle, and car racing.

“The Highway Safety Act of 1966” required states to enact helmet use laws in order to qualify for certain federal safety programs and highway construction funds. By the early 1970s, almost all the states had universal motorcycle helmet laws.

Because of the precedent set with The Highway Safety Act of 1966, the “Children's Bicycle Helmet Safety Act of 1994” made bicycle safety helmet laws voluntary and incentivized grants to States and nonprofit organizations for programs that require or encourage individuals under the age of 16 to wear approved bicycle helmets.

Currently, 21 states, the District of Columbia, the Northern Mariana Islands and the Virgin Islands have a helmet law for bicyclists below a certain age, generally about 16. Only the Virgin Islands require helmets for all bicyclists and 29 states and Guam have no bicycle helmet law.

The state laws, and the accepted helmet testing standards of bicycle helmets for those laws vary depending on when they laws and standards were written because of evolution of the testing standards themselves.

The Snell Foundation had introduced the first bicycle helmet standard in the United States in 1970, but at the time only a light motorcycle helmet could pass the standard, and that meant an unusually heavy helmet for the application of bicycle riding. In 1984 the ANSI (American National Standards Institute) headgear committee adopted ANSI Z80.4, the first workable bike helmet standard for the United States. The Snell Foundation revised their own standard the next year to adjust the requirements to more realistic levels for bicycle riding impacts. By the mid 1980's, bicycle helmets were characterized generally by EPS (expanded polystyrene) hard foam liners, with ABS (acrylonitrile butadiene styrene) or polycarbonate hard shells, and then eventually in the early 1990's, a simple vacuum formed PVC (polyvinyl chloride) shell for decoration over the expanded polystyrene hard foam.

Around the same time, a more ridged, rounded construction utilizing an expanded polystyrene liner and a hard plastic ABS (acrylonitrile butadiene styrene) outer shell, commonly known as a “skate helmet”, was introduced and widely accepted for more extreme activities.

In 1998, the Consumer Products Safety Commission (CPSC) introduced standard 16 CFR Part 1203 that is the safety standard that all bicycle helmets must meet if sold in the United States, and the same safety standard most adopted by many states for their helmet laws. Although some states still refer to older ANSI and ASTM standards, depending on when those laws were written, CPSC CFR Part 1203 is a standard that requires a single impact testing protocol where the helmet must be discarded after one single impact.

The late 1990's saw a rise in extreme sports and included activities such as in-line roller skating, trick skating and skateboarding. To answer these more rigorous demands for helmet protection standards, ASTM International, formerly American Society for Testing and Materials, issued the ASTM F1492 skate helmet standard in the early 2000's, and is a multiple impact standard to reflect the more extreme activities the product is used for.

Because many state laws are antiquated and do not reflect the newer ASTM F1492 multiple impact certification for extreme sport helmets, many of these products are sold under the older CPSC CFR Part 1203 single impact bicycle helmet standard.

In an effort to provide a duel certified (CPSC CFR Part 1203 and ASTM F1492) skate helmet design, I, Paul Dvorak reconfigured the expanded polystyrene hard foam inside liner of a skate helmet design in the form of corrugation with a simple peaks and valleys. Independent testing reports demonstrated a measurable decrease in the amount of G force (A force acting on a body as a result of acceleration or gravity, informally described in units of acceleration equal to one g) passing through the helmet and allowing the helmet to pass both standards.

In order to both remove expanded polystyrene and other materials in the manufacture of all types of safety and sports helmets, and increase the amount of protection for the users head, Safety Helmet Liner Impact Reducing Technology was developed.

### SUMMARY

In accordance with at least one embodiment, an article of headwear comprises an inner liner and an outward layer of corrugated material. Upon impact, the outward layer at least partially collapses, and in so doing absorbs and distributes the forces of the impact.

The present invention addresses and solves the shortcomings of single-impact rated helmets. It provides for the long-term safety of the wearer, without a need for specialized inspection equipment. The invention provides ease of manufacture, by orienting corrugations to allow for fabrication on a single-piece mold.

### DRAWINGS

### Figures

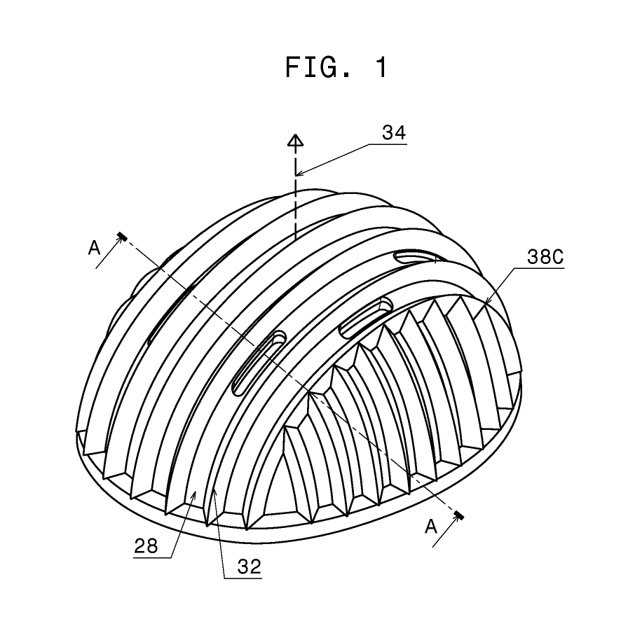

FIG. 1 is a perspective view from above of a first embodiment of the present invention.

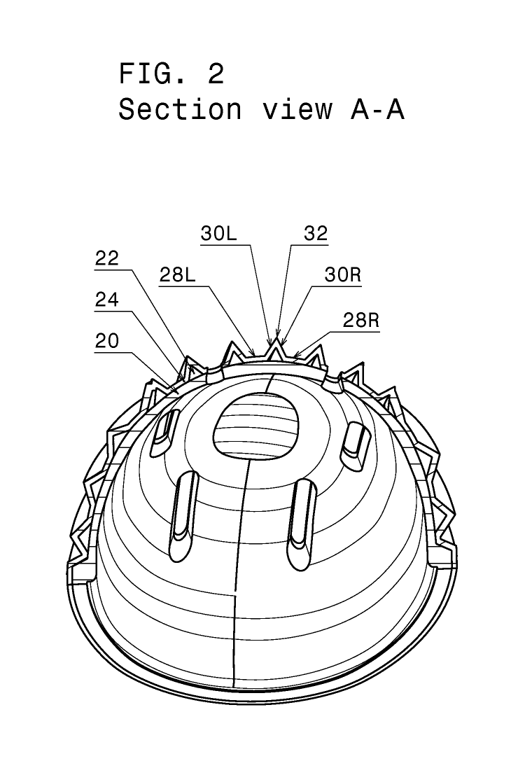

FIG. 2 is a section view from below of an inner liner and a corrugated shell, contained in a first embodiment.

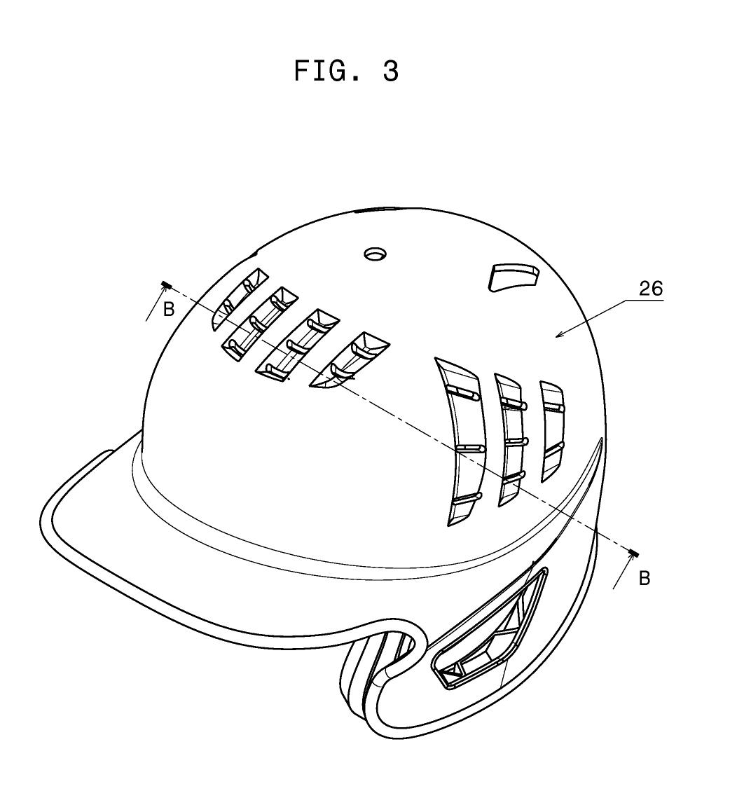

FIG. 3 is a perspective view from above of a second embodiment of the present invention.

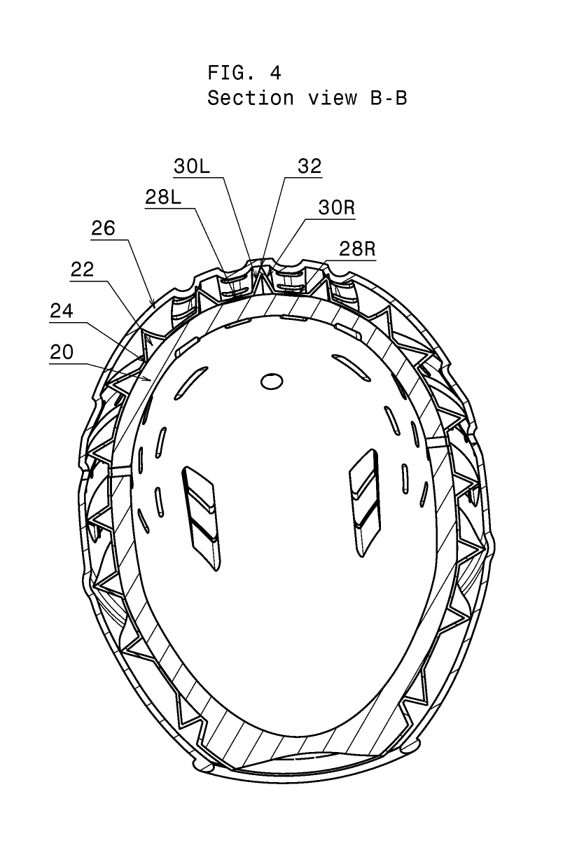

FIG. 4 is a section view from below of the inner liner, the corrugated shell, and an outer shell contained in a second embodiment.

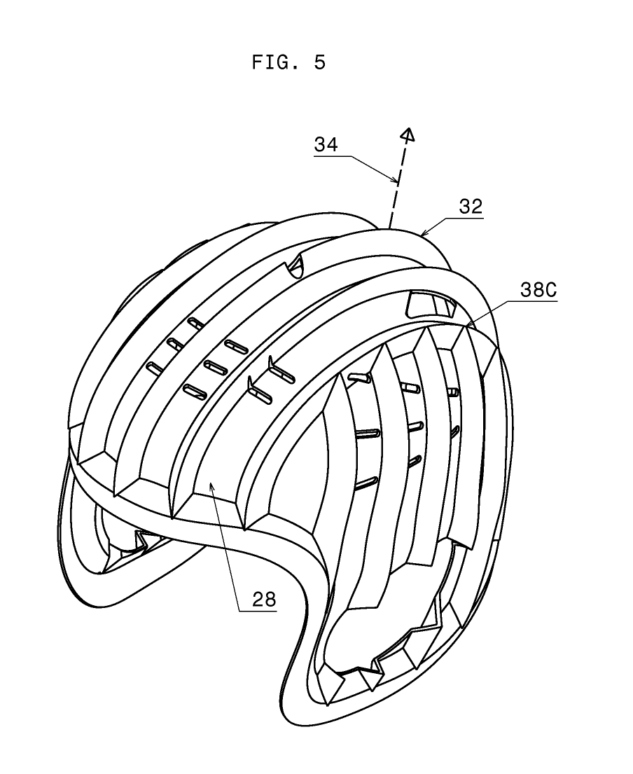

FIG. 5 is a perspective view from above of the corrugated shell contained in the second embodiment.

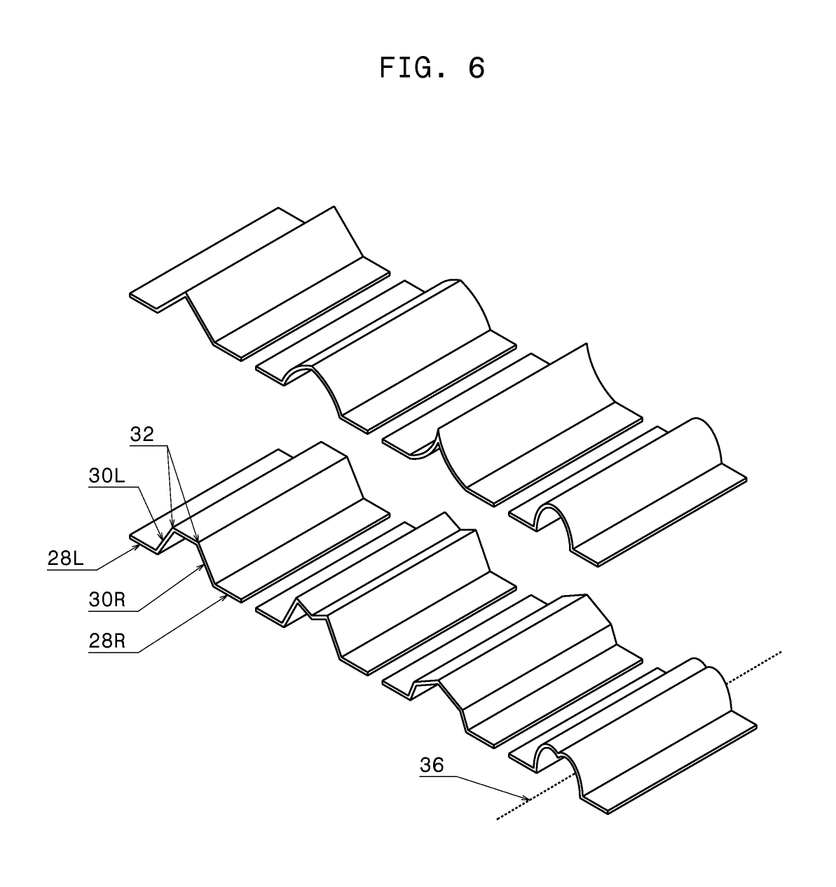

FIG. 6 is a perspective view from above of several possible profiles for the corrugation of any embodiment of the present invention.

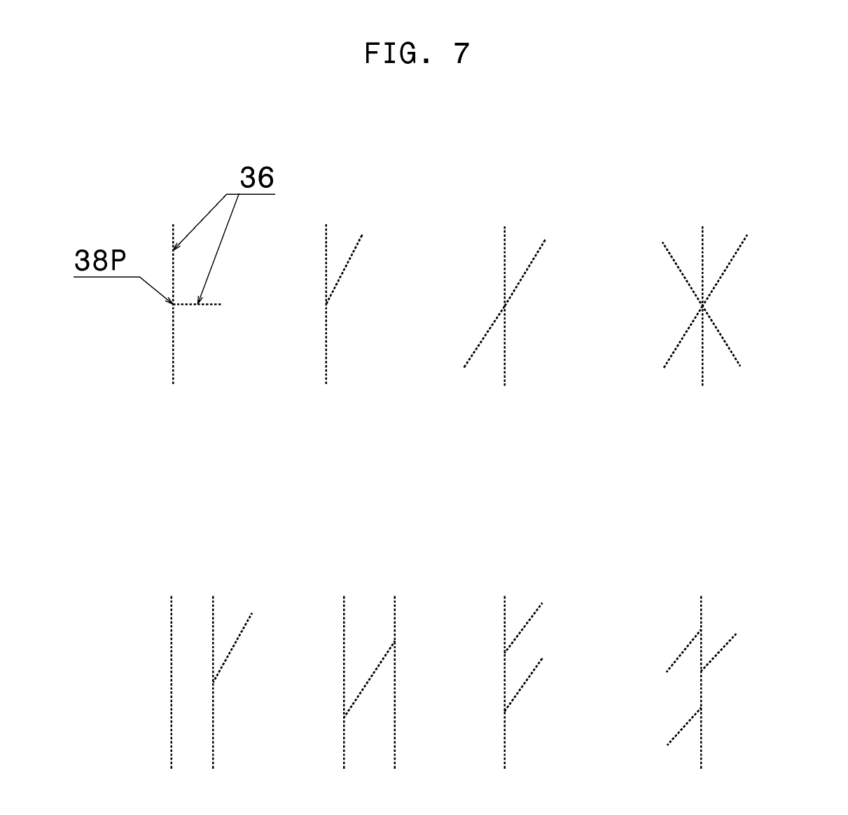

FIG. 7 is a diagram of several possible arrangements of projection lines for the corrugation of any embodiment of the present invention.

### Reference Numerals

20 inner liner
22 chamber
24 corrugated shell
26 outer shell
28 base
28L left base
28R right base
30 legs
30L left leg
30R right leg
32 apex
34 pulling direction
36 projection line
38C corrugation intersection
38P projection line intersection

### DETAILED DESCRIPTIONS

### Embodiments 1-2

In the following descriptions, like reference characters designate like or corresponding parts throughout the several views and embodiments. Also, it is to be understood that such terms as “forward,” “rearward,” “left,” “right,” “upwardly,” “downwardly,” and the like are words of convenience and are not to be construed as limiting terms. Locations, shapes, sizes, materials, numbers, relative positions, angular positions, velocities of motion, ranges of motion, electrical tolerances, mechanical tolerances, and other such properties of the devices within the embodiments may be altered and are not to be construed as limiting factors. Nor should the components comprising an assembly be construed as the only suggested components within that assembly.

Referring now to the drawings, it will be understood that the illustrations are for the purpose of describing embodiments of the invention and are not intended to limit the invention thereto.

FIG. 1 is a perspective view from above of a first embodiment of the present invention. The view comprises a helmet having corrugations, where the corrugations are divided into a base 28 and an apex 32. Also shown is an intersection 38C between two corrugations. The view shows a pulling direction 34, which represents the direction in which the corrugations are removed from a male mold. The view includes a section line A-A, which is referenced in FIG. 2.

FIG. 2 is a section view A-A from below of an inner liner 20 and a corrugated shell 24, contained in the first embodiment. Interposed between the inner liner 20 and the corrugated shell 24 is a chamber 22, which may be empty, pressurized by a gas, or filled with a liquid, gel, or other deformable material. The view illustrates various parts of a single corrugation, which include a left base 28L, left leg 30L, apex 32, right leg 30R, and right base 28R.

FIG. 3 is a perspective view from above of a second embodiment of the present invention. The view shows an outer shell 26.

FIG. 4 is a section view B-B from below of the inner liner 20, the corrugated shell 24, and an outer shell 26 contained in a second embodiment. Interposed between the inner liner 20 and the corrugated shell 24 is a chamber 22, which may be empty, pressurized by a gas, or filled with a liquid, gel, or other deformable material. The view illustrates various parts of a single corrugation, which include a left base 28L, left leg 30L, apex 32, right leg 30R, and right base 28R.

FIG. 5 is a perspective view from above of the corrugated shell contained in the second embodiment, where the corrugations are divided into a base 28 and an apex 32. Also shown is an intersection 38C between two corrugations. The view shows a pulling direction 34, which represents the direction in which the corrugations are removed from a male mold.

FIG. 6 is a perspective view from above of several possible profiles for the corrugation of any embodiment of the present invention. The view illustrates various parts of a single corrugation, which include a left base 28L, left leg 30L, apex 32, right leg 30R, and right base 28R. It also shows profiles having parabolic or otherwise curved segments. The view illustrates a projection line 36, which runs centrally through the single corrugation and within the same plane or curve as the base 28. The projection line is intended to extend beyond the actual limits of any corrugation to the limits of a given corrugated shell.

FIG. 7 is a diagram of several possible arrangements of projection lines for the corrugation of any embodiment of the present invention. This view shows a plurality of projection lines 36 and a plurality of projection line intersections 38P.

### OPERATION—FIGS. 1-7

The operation of these embodiments begins at the instant of impact between the helmet and another object, such as the ground or a projectile. At that moment, the outer shell 26, if one exists, begins to deform and transfer mechanical energy to the nearby apexes 32. If there is no outer shell, then the mechanical energy is transferred directly from the projectile or other object to the apexes 32. The legs 30 begin to bow inward or outward as the apex collapses partially or completely to the plane of the base 28.

### CONCLUSION, RAMIFICATION, SCOPE

Thus the reader will see that at least two embodiments of the present invention provide articles of headwear which absorb multiple impacts without damage to the headwear itself. These embodiments allow a small, lightweight helmet to perform comparably to a larger, heavier one, and they provide a simple method of manufacture.

While the above description contains many specifics, these should not be construed as limitations on the scope of the invention, but rather as exemplifications of two embodiments thereof. Many other variations are possible. For example:
1. While the above embodiments focus specifically on plastics, the shells may be made of any flexible material.
2. While the above embodiments employ a single corrugated shell and single outer shell, any multiples of these may be used
3. While the above embodiments employ a single inner liner, any multiple of this may be used.
4. While the above embodiments arrange layers in the order of inner liner, corrugated shell, outer shell; any order of layers may be used.
5. While the above embodiments employ substantially solid layers, perforated layers may be used.

Accordingly, the scope of the invention should be determined not by the embodiments illustrated, but by the appended claims and their legal equivalents.

I claim:

1. An article of headwear which includes an at least one layer of flexible material, such layer having an at least one ridge, with such ridge being defined in relation to a central projection line

2. The article of headwear of claim 8, in which the cross-section of the at least one ridge comprises a left base, a left leg, an apex, a right leg, and a right base.

3. The article of headwear of claim 8, in which the cross-section of the at least one ridge comprises a left base, a left leg, a plateau, a right leg, and a right base.

4. The article of headwear of claim 8, in which the cross-section of the at least one ridge comprises a left base, a substantially curved segment, and a right base.

5. The article of headwear of claim 1 in which at least two of the central projection lines are substantially parallel to each other.

6. The article of headwear of claim 5 in which at least one of the at least two parallel central projection lines is intersected by an at least third central projection line.

7. The article of headwear of claim 1 in which at least three of the central projection lines intersect at a hub.

8. The article of headwear of claim 5 in which the projection lines are substantially parallel to a single pulling direction.

9. A method of manufacture in which a sheet of thermoplastic is heated to a semi-liquid state, then placed upon a mold having corrugated forms upon its surface, then having vacuum applied to the mold side of the sheet, then having the cooled sheet lifted from the mold.

10. A method of manufacture in which a corrugated shell is removed from an injection mold.

11. The article of headwear of claim 6 in which the projection lines are substantially parallel to a single pulling direction.

12. The article of headwear of claim 7 in which the projection lines are substantially parallel to a single pulling direction.

13. The article of headwear of claim 11, in which the cross-section of the at least one ridge comprises a left base, a left leg, an apex, a right leg, and a right base.

14. The article of headwear of claim 11, in which the cross-section of the at least one ridge comprises a left base, a left leg, a plateau, a right leg, and a right base.

15. The article of headwear of claim 11, in which the cross-section of the at least one ridge comprises a left base, a substantially curved segment, and a right base.

16. The article of headwear of claim 12, in which the cross-section of the at least one ridge comprises a left base, a left leg, an apex, a right leg, and a right base.

17. The article of headwear of claim 12, in which the cross-section of the at least one ridge comprises a left base, a left leg, a plateau, a right leg, and a right base.

18. The article of headwear of claim 12, in which the cross-section of the at least one ridge comprises a left base, a substantially curved segment, and a right base.

19. The method of manufacture of claim 9 in which the sheet is shaped as a helmet.

20. The method of manufacture of claim 10 in which the sheet is shaped as a helmet.
